(19) United States
(12) Patent Application Publication
(10) Pub. No.: US 2002/0187545 A1
(43) Pub. Date: Dec. 12, 2002

(54) Bioremediation of hydrocarbon contaminated waste using corn material

(76) Inventors: Peter Calcavecchio, Milford, NJ (US); Evelyn Nobles Drake, Bernardsville, NJ (US); David William Savage, Lebanon, NJ (US)

Correspondence Address: ExxonMobil Research and Engineering, P.O. Box 900, Annandale, NJ, 08001-9974, US

(21) Appl. No.: 09/878,585

(22) Filed: Jun. 11, 2001

(51) Int. Cl. C12S 1/00

(52) U.S. Cl. 435/262; 435/262.5

(57) ABSTRACT

Hydrocarbonaceous contaminants are bioremediated using corn material, such as corn waste and corn oil. The hydrocarbonaceous contaminant is contacted with the corn material in the presence of nutrients and bacteria effective for bioremediation. The contaminant is typically on a solid substrate, admixed with particulate solids or on water. Corn oil is typically applied to large area spills on water, beaches, solid and rocky ground and the like by spraying, while solid corn material is typically used for all other applications and mixed in with the contaminant.

### BACKGROUND OF THE DISCLOSURE

1. Field of the Invention

The invention relates to using corn material to enhance the bioremediation of hydrocarbonaceous contaminants. More particularly, the invention relates to the use of material derived from the corn plant, such as solid corn waste and oil, to enhance the biodegradation of hydrocarbon contaminants on soil, in waste solids, as oil spills on water and the like.

2. Background of the Invention

The biological treatment or bioremediation of waste water, soil, oil spills, refinery waste, refinery and waste water treatment sludge contaminated with hydrocarbonaceous contaminants, and the like, is known. These processes depend on natural bacteria or fungi to biodegrade the typically hydrocarbon hydrocarbonaceous contaminants, into more environmentally friendly materials (bioremediation) and include, in addition to the well known aerobic and/or anaerobic processes for waste water treatment, processes used for the treatment of oil spills on water, land and the other contaminated substrates mentioned above. Cellulosic and lignin containing materials, along with bacteria and, if needed, nitrogen and phosphorous bacteria nutrients, are often used in the bioremediation of soil and other particulate solid or semi-solid substrates, such as sludges. Oil spills, especially on water, are particularly troublesome to treat, as are oil producing well sites contaminated with crude oil. Waste water processes, in addition to producing bioremediated wastewater, also produce contaminated sludge. This sludge must also be treated, to biodegrade the hydrocarbonaceous contaminants remaining in it. One or more cellulosic materials, such as wood chips and straw, are typically added to the sludge, as what is referred to as an amendment material, and mixed therewith to provide porosity and sites for the bioactive bacteria When treating land contaminated with hydrocarbonaceous material, such materials are mixed in with the land or soil, to form a composted mass in which the hydrocarbons biodegrade into carbon dioxide and water.

Examples of such processes are disclosed, for example, in U.S. Pat. Nos. 4,415,662; 4,891,320; 5,716,839; 5,609,667 and 5,624,565. The '662 patent discloses the use of a particular fungus to degrade petroleum crude oil and products. The '320 patent relates to bioremediating polyhalogenated compounds, such as DDT, using white rot fungus in the presence of a ligneous matrix comprising wood, wood products and humus. The '839 patent uses cedar wood chips and nutrients for bioremeditating hydrocarbon contaminated soil, while the '667 patent uses a cellulose dust containing ammonium nitrate. In these patents, other cellulosic and ligneous materials, including corn cobs, are suggested as being potentially useful, but are not disclosed as having been tested. It is desirable that amendment material added to the sludge or land to be treated be environmentally non-toxic, not add excessive bulk to the soil, be inexpensive, and preferably impart properties to the final product which enable it to be used in and for land fills. Very bulky materials, such as straw and particularly wood chips, when used in high volume amounts often add a high volume fraction to the material being treated. The use of wood chips can increase the volume of the contaminated solids being bioremediated by as much as 100%. Such bioremediated material may not have the soil compaction and strength properties necessary to support weight in a land fill application. There is a need for a bioremediation process in contaminated areas, such as crude oil production sites, that will provide reasonably rapid biodegradation of the contaminant, with minimal effect on soil reuse (e.g., minimal or no reduction in compressive strength or load bearing capacity).

### SUMMARY OF THE INVENTION

The present invention relates to the use of corn material for the bioremediation of a hydrocarbonaceous contaminant on solid or liquid substrates or admixed with particulate solids. Thus, in a broad sense the invention relates to a process which uses corn material for the bioremediation of hydrocarbonaceous material in contact or admixture with soil, sludge, beaches, other solid substrates and water, wherein the process comprises contacting and/or admixing the hydrocarbonaceous contaminant with the corn material. By corn material is meant natural products obtained from the corn plant that have not been chemically altered to change their original chemical identity, so as to make them unsuitable for use with the process of the invention. This may include the stalks, leaves, husks, silk, ground or shredded cobs, kernels, the germ, gluten and starch derived from the kernels (hereinafter “solid corn material”), as well as corn oil. However, as a practical matter the solid corn material will comprise what is known as corn waste, which includes one or more of the stalks, leaves and husks, and typically all three. When treating soil or sludge contaminated with a hydrocarbonaceous contaminant, the process comprises mixing the corn material with the soil or sludge to be treated. It is preferred that contaminated soil or sludge be composted with animal manure as part of the bioremediation. Compost comprising animal manure is preferred in the practice of the invention. Solid corn material is preferred for the bioremediation of all but spills on water, rocky land and beaches, solid structures and the like, where it is not possible to mix or till in the corn material. In these cases, the contaminated areas and structures are treated with corn material comprising corn oil. The corn oil is easily applied by spraying, as is explained in detail below. In the practice of the invention, unless nutrients effective for the bioremediation are present in the material being treated in sufficient amounts, then compounds which release nitrogen and phosphorus are also applied along with the corn material. The nutrients are applied in an amount so as to achieve a C:N:P ratio broadly ranging from about 300:1:1 to 10:1:1. If desired or if necessary due to a large area to be covered, a solution of the nutrients may be applied to the soil, sludge, or spill by spraying. If corn oil is being sprayed onto a contaminated area, the oil may be applied neat or it may first be emulsified in aqueous media, which may or may not comprise an aqueous solution of the nutrients, and the resulting emulsion applied by spraying. When used for treating soil, the bioremediation process of the invention provides reasonably rapid biodegradation of the hydrocarbonaceous contaminant, with minimal effect on soil reuse (e.g., minimal or no reduction in compressive strength or load bearing capacity). The corn material provides more rapid biodegradation than wood chips or straw, without increasing the volume of the treated solids. This makes it particularly useful in contaminated areas that may require rapid reuse of the contaminated soil, such as crude oil production and oil refinery sites, sandy beaches, and the like.

### BRIEF DESCRIPTION OF THE FIGURES

FIG. 1 is a schematic side view of a laboratory bioreactor used in evaluating the practice of the invention.

FIG. 2 is a graph illustrating the volume decrease of a composted mix containing oil refinery sludge according to the practice of the invention and the prior art.

FIG. 3 illustrates the amount of hydrocarbon degradation in the composted mixes of FIG. 2.

FIG. 4 shows the amount of hydrocarbon degradation in these same composted mixes, in terms of methylene chloride extracted oil.

FIG. 5 is a bar graph showing the comparative degradation of the polynuclear aromatic hydrocarbons in these composted mixes.

### DETAILED DESCRIPTION

The invention relates to the use of corn material for the bioremediation of a hydrocarbonaceous contaminant on solid or liquid substrates, or admixed with particulate solids, wherein the corn material is contacted and/or admixed with the hydrocarbonaceous contaminant. Illustrative, but nonlimiting examples of solid substrates according to the practice of the invention includes any non-particulate solid substrate, such as metal, plastic, rock, foundations, piers, docks, cementatious (including cement and concrete) masses, and the like, as well as scattered rocks as may occur, for example, on Alaskan and other rocky beaches, and the like. It is also meant to include particulate solid substrates, such as soil, sand, sandy beaches and the like. In the practice of the invention, the substrate may also comprise the solid corn material. In this embodiment, the hydrocarbonaceous material is contacted and mixed with the solid corn material. Examples of hydrocarbonaceous contaminants in admixture with particulate solids include various sludges, such as oil refinery tank bottoms, refinery and other sewer sludges and sludges resulting from refinery and other waste water treatments, as well as soil and sand. Hydrocarbonaceous contaminants often penetrate down into soil and sand in oil refineries, crude oil production sites and beaches, as well as lying on top of the soil or sand. With respect to sludges, as is known, the types of sludges mentioned above typically comprise more than 25% and even more than 50% by weight or volume of particulate solids in admixture with a hydrocarbonaceous contaminant, and may range in consistency from a fluid to a viscous semi-solid having the consistency of a thick grease. Sludges contaminated with a hydrocarbonaceous contaminant that have been successfully bioremediated in tests conducted according to the practice of the invention, have included oil refinery tank bottoms from both crude oil and general tankage, oil refinery process sewer waste, and sludge resulting from refinery process waste water treatment (treated sludges). As is known, oil refinery tank bottoms sludges typically comprise heavy hydrocarbonaceous material that can be difficult to bioremediate and are often more than 50 wt. % particulate solids. Disposal of these sludges by bioremediation according to the practice of the invention can eliminate or at least reduce the cost and liability of landfill disposal of these wastes. By a hydrocarbonaceous material or contaminant, according to the practice of the invention, is meant a primarily hydrocarbon material obtained or derived from crude petroleum oil, from tar sands, from coal liquefaction, shale oil, and hydrocarbon and chemical synthesis processes. Any type of soil may be treated according to the process of the invention.

With respect to soils and other (e.g., sand) particulate substrates contaminated with hydrocarbonaceous material, in order to minimize the time required for satisfactory bioremediation, it is preferred in the process of the invention that the amount of hydrocarbonaceous material in the soil be greater than 3 wt. % and preferably at least 10 wt. %, so as to produce an elevation in the temperature to above ambient during the treatment. For example, during soil bioremediation tests conducted according to the practice of the invention and composted with horse manure, temperature spikes in the composted soil consistently reached as high as 25° C. above ambient. When the temperature drops, mixing the composted soil mix to improve aeration will help to increase or maintain the elevated temperature during the bioremediation process. Rapid contaminant degradation occurs during this period of elevated temperature, followed by a plateau in the rate of degradation when the process returns to ambient. There is also a correlation of lower oxygen content in the composted pile with increase in temperature, which is additional evidence of an increase in oil degrading microbiological activity at elevated temperatures. When treating soil, sludge or other particulate solids contaminated with hydrocarbonaceous material, the process of the invention preferably comprises mixing the corn material with the soil or sludge to be treated. Solid corn material is preferred. It is preferred that the contaminated soil or sludge be composted with a compost comprising animal manure, as part of the bioremediation. Still further, it may also be necessary or preferred to add, to the material being bioremediated, an inoculum containing bacteria known to be useful for bioremediating the hydrocarbonaceous contaminant. This is necessary when the material being treated possesses no known remediating bacteria, such as solid substrates, beaches that do not contain vegetation and the like. While many sludges contain such bacteria, including tank bottoms sludge, an inoculum may be added to refinery and other tank bottom sludges, to speed up the bioremediation. Such an inoculum may simply comprise aged soil contaminated with hydrocarbonaceous matter that contains bioremediating bacteria, such as aged refinery soil or aged soil from a crude oil production site, as both contain bacteria which biodegrade hydrocarbonaceous material. The inoculum may also comprise a media containing one or more strains of cultivated bacteria known to be useful for bioremediating hydrocarbonaceous contaminants.

Using compost along with the corn material is preferred for a relatively small volume (e.g.,≦400-500 cubic yards) of material to be treated and a relatively high (e.g.,≧5-10 wt. %) hydrocarbonaceous contaminant content, when in admixture with particulate solids in the waste to be treated. However, the invention is not limited to this particular use of compost as is explained below. The actual volume to be treated is limited only by the amount of solid corn material and compost available and the ability to till it into the contaminated waste. Illustrative, but nonlimiting and typical applications include tank bottom sludge from tank farms and oil refineries, treated and untreated sewer sludge and the like. These high contaminant applications are difficult to treat in-situ and often the only other choice is to ship the waste to a hazardous waste landfill at a high cost, and with the potential of future liability. Composting aids in the biodegradation of the contaminated waste through increased microbiological activity and the associated heat generated, which produces an elevated temperature in the biodegrading waste. Faster bioremediation will be achieved if the mixture of waste, corn material, nutrients and manure is covered with plastic or other material in a pile configuration, as opposed to being spread out. This retains the desired level of moisture in the mix and results in greater heat generation, leading to faster bioremediation. Using compost and a cover means with the corn material treatment is also preferred for large area contaminated sites, including soil and beaches, into which the compost and corn material can be tilled, provided that the material can be transported to the contaminated site. Composting in any manner also aids in moisture retention which, for contaminated particulate solids material, will range from about 5 to 40 wt. % and preferably from 10 to 20 wt. % moisture in the mix. An important advantage of using the corn material for bioremediation according to the practice of the invention, is that the corn material biodegrades in only a few weeks (the time period in which most biodegradation occurs) compared to the use of straw or wood chips, which may take a year or longer to significantly biodegrade. Laboratory tests using corn material have revealed that most of the hydrocarbonaceous contaminant in the waste biodegrades during the initial period of elevated temperature in the first four to six weeks and tends to level off after that. Other important advantages of using the corn material include (i) biodegradation of the corn material with the contaminant, thereby maximizing the microbial activity and heat generation, and (ii) minimizing added volume to the remediated substrate material. Lower added volume is a result of the low bulking and high degradation rate properties of the corn material. By lower volume is meant a lower volume of the treated waste as compared, for example, to higher bulking remediation materials such as wood chips, straw and the like. The amount of solid corn material used in the process of the invention will broadly range from about

Some applications are not amenable to mixing solid corn material with a contaminated substrate. This includes, for example, in addition to spills on water and on the non-particulate solids mentioned above, spills and leachates on soils and beaches in which the contaminated area is too large, remote or inaccessible for mixing and tilling equipment, and also where the required amount and/or transportation of solid corn material is too great or difficult. In such cases corn oil is used. Corn oil is typically recovered from corn by a combination of mechanical means and solvent extraction, and therefore undergoes no change in its chemical nature. The corn oil may be applied to the contaminated area or structure by spraying. Depending on the size and location, the spray application may be achieved by ground equipment, from the air or from water. However, in some cases it will be preferable to emulsify the corn oil in water or aqueous media. For example, the corn oil may be emulsified, using a suitable emulsifier, in water or aqueous media comprising a solution of nutrients, followed by spray applying the emulsion comprising the corn oil emulsifier and nutrients to the contaminated area in a single step. This latter method is preferred for oil spills on water and large area contaminated sites.

Unless nutrients for the bioremediating bacteria are present in the hydrocarbonaceous contaminant or contaminated substrate in an amount sufficient for the bioremediation, then one or more nutrient compounds that release nitrogen and/or phosphorus, and typically both during the bioremediation, must also be applied. Nitrogen and phosphorus serve as nutrients to the bacteria remediating the material being treated. The nutrients are applied to the sludge, soil or spill in an amount so as to achieve a C:N:P ratio broadly ranging from about 300:1:1 to 10:1:1, preferably from 200:1:1 to 20:1:1, and more preferably from 100:3:1.5 to 100:1.5:0.5. Such compounds may or may not be water soluble. Water soluble nutrient compounds may be applied by spraying a solution of such in water. Further, a suitable inoculum may be dispersed in water or aqueous media and spray applied by itself or along with the nutrients. When corn oil is spray applied, the oil may be emulsified in aqueous media containing nutrients and an inoculum. Thus, all three components may be applied at the same time. This is a particularly preferred method of treating spills on water, beaches and the like, where it is not feasible to apply and till in solid corn material, manure or a solid inoculum.

While it is preferred to use all corn material, due to a lack of corn material at a particular location or for any other reason, other amendment material may be used or admixed with the corn material in the process of the invention. Thus the invention comprises using corn material, which includes the use of other materials along with the corn material, but preferably mostly corn material and more preferably all corn material. The corn material of itself is preferably selected from the group consisting of corn stalks, leaves, husks, silk, corn cob particles, kernels, germ, gluten, starch derived from the kernels, oil and mixture thereof, with solid corn material preferably comprising corn waste selected from the group consisting of the stalks, leaves, husks and mixture thereof

The amount of corn material, on a weight basis, that may be employed in the practice of the invention may broadly range from 0.01 to 18 solid corn material/TPH or 0.02 to 20/carbon and 0.01 to 8 corn oil/TPH or 0.01 to 10 corn oil/carbon. Actual laboratory and field tests have employed corn material, on a weight basis, in the range of from 0.1 to 3.3 solid corn material/TPH or 0.2 to 4.0/carbon and 0.1 to 0.8 corn oil/TPH or 0.1 to 1 corn oil/carbon. Those skilled in the art will appreciate that it is not always possible to quantify, a′ priori, the exact amount of corn material that will be used, because it will depend on the TPH (Total Petroleum Hydrocarbon) content of the contaminated material (e.g., sludge) or site or location, the amount of solids present, the amount of any soil used and/or manure, inoculum, etc. and the amount of corn material available. Nevertheless the amount of solid corn material, typically corn waste, used will be sufficient to produce an initial increase in the volume of material being treated by about 5-50%, preferably 10-40% and more preferably 15-30%. In the practice of the invention, the bioremediation is typically conducted until the amount of hydrocarbonaceous contaminant has been reduced by at least 50 wt. %. The examples below will, in addition to the forgoing disclosure, provide guidelines to the practitioner enabling facile practice of the invention without the need for undue experimentation.

The invention will be further understood with reference to the examples below.

### EXAMPLES

### Composted Test Examples

### Laboratory Reactor

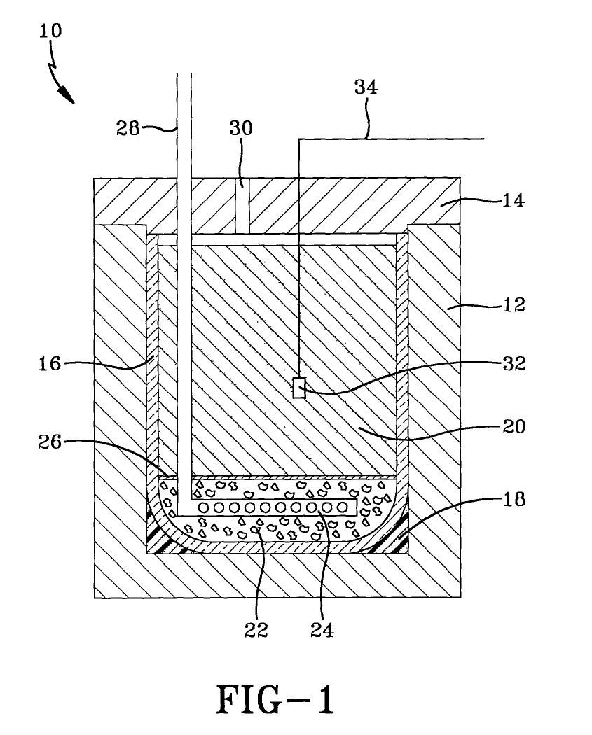

In these examples, laboratory tests were conducted in laboratory reactors. Each reactor comprised a 3 liter glass beaker which was insulated by placing it in a covered polystyrene foam boxes having a 5.5 cm wall thickness. Spray foam insulation was used to cement the beaker to the bottom of the box and fill the void space at the bottom, that would otherwise have existed due to the curvature of at the bottom of the beaker. This was done to simulate a composted pile. The insulated reactors were designed to provide passive aeration to the composted mass, via a hole drilled into the polystyrene covers. A stainless steel tube passed through a second hole in each cover, down through the composted mass and terminated below it in a horizontal perforated coil, near to the bottom of the beaker. The coil was sandwiched in between two layers of gravel, each ½ inch thick, with geo textile cloth separating the composted mass from the gravel and coil. Periodic oxygen measurements were made by drawing air up through the coil and tube, using a Gastech GT-201 oxygen meter. A thermocouple placed in the composted mass enabled continuous temperature measurements, which were recorded using a data logger. A schematic of these reactors is shown in FIG. 1. Thus, bioreactor 10 comprises a polystyrene foam box 12 covered with a polystyrene foam cover or lid 14, containing a 3 liter glass beaker 16 within. The sprayed foam insulation 18 cements the beaker into the box and occupies an otherwise void space therein. The composted hydrocarbon contaminated waste mix 20 fills most of the beaker. Gravel 22 is layered above and below perforated coil 24, with geo cloth 26 placed over the gravel, to separate it from the compost 20 above. Coil 24 is closed at its interior end (not shown) in the gravel and its other end extends upward through the gravel, composted mass and lid, as stainless steel tube 28 which is closed at its other end, except when drawing air up through it, to make the oxygen measurements. A bore 30 in the top of the lid enables passive aeration to the composted mass. A thermocouple 32 is connected to a thin, insulated electric cable which passes up through the composted mass and lid, and is electrically connected to means (not shown) for recording the temperature in the composted mass 20 as a function of time.

### Contaminated Waste Mix

In each of these composting tests, the hydrocarbon contaminated waste was 1,593 grams of sludge from oil refinery waste (18-19 wt. % TPH), to which was added 390 grams of aged hydrocarbon contaminated refinery soil used as an inoculum (source of hydrocarbon degrading microbes). To this mixture was added 200 grams of horse manure (less straw) as compost. Care was taken to insure that the volume of manure added to each sample was kept fixed. Also added was 8 grams of diammonium phosphate dissolved in 100 grams of water. This was enough to provide 1065 wppm of nitrogen based on the sludge and 709 wppm based on the total weight (including water) of the composted sludge. In the three examples below, the amount of solid corn waste, straw and wood chips employed were sufficient to achieve the same volume increase of the material being treated.

### Example 1

100 grams of corn material generally regarded as waste and which is typically used as cattle feed, was blended into the above contaminated waste mix. The corn waste comprised the stalks, leaves and husks and was about 30 volume % of the volume of the contaminated sludge waste mix. The C:N:P ratio in this example was 64:0.9:1.0. This blend was placed in one of the reactors for testing. Throughout the test, a white fungus was present in the corn material and contributed to the microbiological activity.

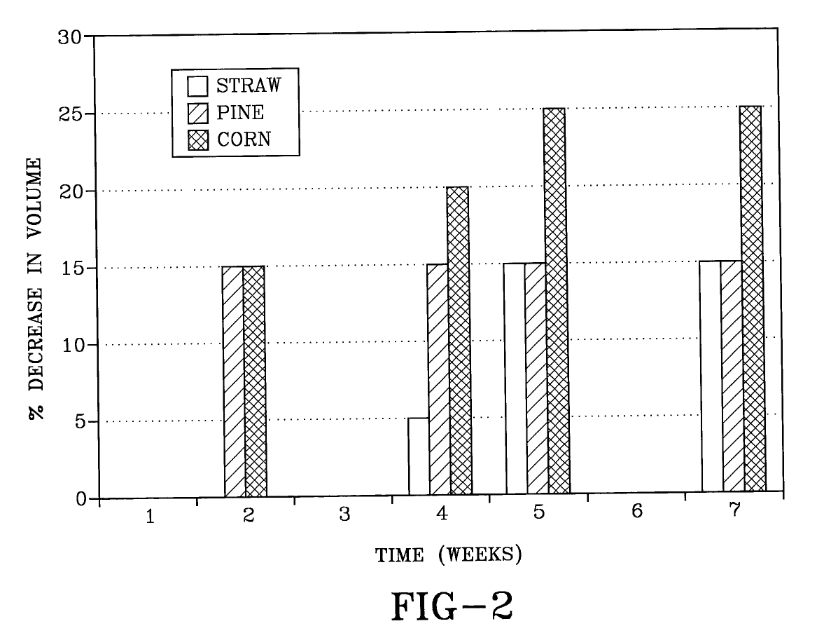

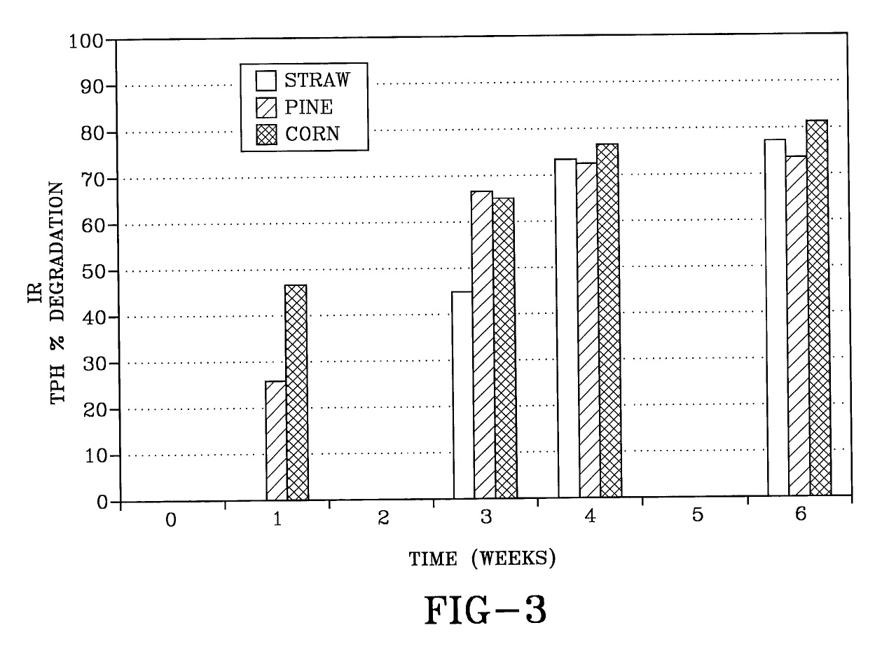

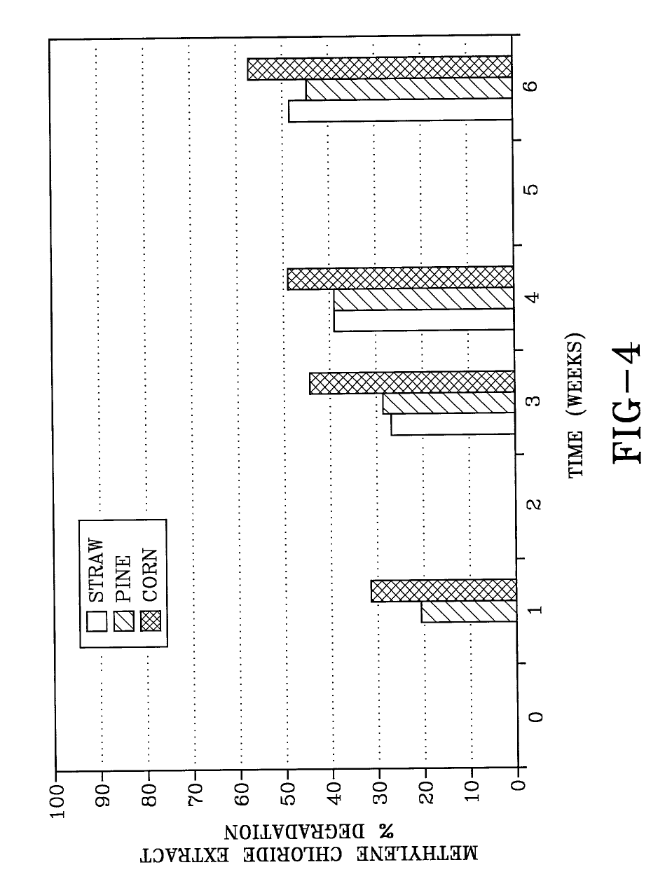

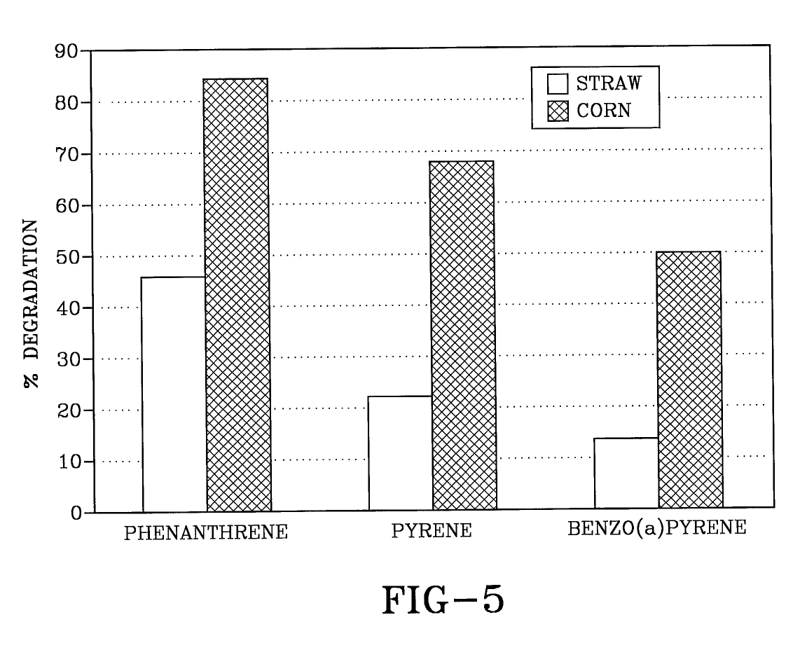

Compared to the two comparative examples A and B below, FIG. 2 shows that the sludge containing the corn material exhibited the greatest decrease in total volume over a 4 to 7 week period. Infra-red analysis for Total Petroleum Hydrocarbon (TPH) showed that the use of the corn material exhibited a total TPH % degradation rate significantly higher than using straw or the pine wood chips. This is illustrated in FIG. 3. The percent oil degradation, based on methylene chloride extractable oil, was also greater for the corn waste, compared to the straw and pine chip wood amendment materials. This is shown in FIG. 4. FIG. 5 illustrates that the removal of polynuclear aromatic hydrocarbons (PAHs) was faster with the corn material after one week. Finally, temperature measurements showed an earlier temperature increase of the mix containing the corn material, compared to those containing either the pine wood chips or straw. This is an indirect indicator that the corn material enhanced microbiological activity.

### Comparative Example A

This experiment was similar to that of Example 1, except that 33 grams of straw was used instead of corn material. Thirty three grams were used to achieve the same amount of volume bulking as with the corn waste, due to the lower density of the straw. The test results are described above and shown in FIGS. 2 through 5.

### Comparative Example B

This example was also similar to Example 1, with 100 grams of wood chips being used instead of the corn material. As is the case for comparative example A, the test results for these wood chips are also described above and shown in FIGS. 2 through 5.

### Land Farming Tests

In all of these tests, the soil was placed in a 7″×12″×4″ rectangular container to simulate a land farming application. In each test the soil was about 2″ deep. The treatment materials and the nutrients were dissolved or dispersed in water and spray applied onto the soil and then blended into it. The soil was an aged oil refinery soil contaminated with about 2 wt. % TPH. The source of the hydrocarbonaceous contaminant was unknown. In each experiment 2,000 grams of this soil were used. These land farming tests were conducted to demonstrate the efficacy of the invention on enhancing land farming practices and cleaning oil spill contaminated beaches and land.

### Example 2

In this example corn material as corn oil was the bioremediation agent and was used in an amount of 0.12 grams of oil per gram of carbon. The amount of carbon in the soil was based on 85% TPH, using the TPH Test Method 418.1 of the New Jersey EPA. The nutrients added were, (a) 335 ppm of nitrogen from urea to achieve a 50:1 C:N ratio and (b) 170 ppm available phosphorous from disodium phosphate to achieve a 100:1 C:P ratio. This corn oil treatment resulted in the appearance of a white fungus growth, similar to that observed in Example 1. After 52 weeks of treatment, the TPH reduction was 75 wt. %. This was greater than that achieved using the commercial bioremediation treatments described below. The corn oil is believed to be environmentally neutral with respect to plant and animal life forms. Further, there are no handling problems associated with it as there are with solvents, such as butoxy ethanol, used in certain commercial treatments outside the scope of this invention.

### Example 3

This experiment was similar to that of Example 2, except that in addition to the corn oil, urea and disodium phosphate, 0.12 grams of a commercial hydrophillic surfactant, trilaureth phosphate was also used in an amount of 0.12 grams per gram of carbon, based on 85% of THP. The results for this experiment were similar to that of Example 2, in that the TPH reduction after 52 weeks was also 75%. The trilaureth phosphate enabled the corn oil to be dispersed in water as an oil-in-water emulsion, with the nutrients in solution in the aqueous phase. This enabled the corn oil and nutrient package to be uniformly and easily spray applied in one step.

### Comparative Example C

This experiment was similar to the experiment of Example 2, except that Inipol, a commercially available bioremediation treatment was used. The Inipol was used at 0.12 grams per gram of carbon based on 85% of TPH. The Inipol also provided about the same amount of nitrogen and phosphorus nutrients as used in Examples 2 and 3. After 52 weeks of treatment, the Inipol reduced the TPH by 68 wt. %. Inipol (Inopol EAP-22) is a commercial and proprietary product of Elf Atochem, North America, headquartered in Philadelphia. Inipol EAP-22 is believed to comprise, in rounded numbers, 7 wt. % nitrogen and 0.6 wt. % phosphorus and contain 26% oleic acid, 24% trilaureth phosphate, 16% urea, 27% water and 11% butyl oxyethanol (butyl cellosolve).

### Comparative Example D

This experiment was also similar to the experiment of Example 2, except that Customblen, another commercially available bioremediation treatment, was used to provide 0.07 grams of Customblen per gram of carbon. In addition to the Customblen, disodium phosphate was also added to provide 0.036 grams of additional phosphorus per gram of carbon. The Customblen was used in an amount to provide about a 50:1 C:N ratio and about a 100:1 C:P ratio from both the Customblen and the disodium phosphate. After 52 weeks of treatment, the TPH was reduced by 65 wt. %. Customblen is a trade name for a commercial product used in bioremediation applications and is available from the Scotts Lawn Company, in Ohio. Customblen is believed to comprise about 28 wt. % nitrogen, 3.5 wt. % phosphorus and contain calcium phosphate, ammonium phosphate and ammonium nitrate.

### Example 4

About 1,000 tons of crude oil tank bottoms sludge is removed from the bottom of a crude oil storage tank by bulldozers. This is mixed with approximately 1,000 tons of aged refinery soil contaminated with hydrocarbonaceous material as an inoculum. About 1,250 bales of corn waste comprising stalks, leaves and husks is also mixed in, along with a nutrient comprising diammonium phosphate. The nutrient is used in an amount so as to provide 800 wppm of nitrogen in the mix. The resulting mixture is bull dozed into a large shed to form a mass approximately 18 yards long×16 yards wide, by 1 yard high. After from about 2-4 months, the TPH is reduced sufficiently for the bioremediated mass to be used as fill. The amount of hydrocarbonaceous contaminant present after bioremediation is less than 95 wt. % of the original amount.

It is understood that various other embodiments and modifications in the practice of the invention will be apparent to, and can be readily made by, those skilled in the art without departing from the scope and spirit of the invention described above. Accordingly, it is not intended that the scope of the claims appended hereto be limited to the exact description set forth above, but rather that the claims be construed as encompassing all of the features of patentable novelty which reside in the present invention, including all the features and embodiments which would be treated as equivalents thereof by those skilled in the art to which the invention pertains.

What is claimed is:

1. A process for bioremediating hydrocarbonaceous material comprises contacting it with corn material.

2. A process according to claim 1 wherein said contacting occurs in the presence of bacteria effective for said bioremediation.

3. A process according to claim 2 wherein said corn material comprises solid corn material corn oil or mixture thereof.

4. A process according to claim 3 wherein said hydrocarbonaceous material to be bioremediated is in contact with a solid substrate, a particulate solid substrate or water.

5. A process according to claim 4 wherein said contacting occurs in the presence of one or more nutrients effective for said bioremediation.

6. A process according to claim 5 wherein said nutrients comprise one or more compounds which release nitrogen and phosphorus.

7. A process according to claim 6 wherein said substrate is water and wherein said corn material comprises corn oil.

8. A process according to claim 7 wherein said oil is applied by spraying.

9. A process according to claim 6 wherein solid corn material comprising corn waste and compost are mixed with said hydrocarbonaceous contaminant.

10. A process for bioremediating hydrocarbonaceous material comprises contacting it with corn material comprising solid corn material, corn oil or mixture thereof, in the presence of bacteria and nutrients effective for said bioremediation at a C:N:P ratio of from 300:1:1 to 10:1:1.

11. A process according to claim 10 wherein the amount of corn material used, on a weight basis, ranges from 0.01 to 18 solid corn material/TPH or 0.02 to 20/carbon and 0.01 to 8 corn oil/TPH or 0.01 to 10 corn oil/carbon.

12. A process according to claim 11 wherein said hydrocarbonaceous material is in admixture with particulate solids and wherein said corn material comprises solid corn material which is mixed into said hydrocarbonaceous material in an amount sufficient to cause at least an initial increase in the volume of said material being treated of at least 5%.

13. A process according to claim 12 wherein said volume increase ranges from 5-50%.

14. A process according to claim 13 wherein compost is also mixed in with said hydrocarbonaceous material.

15. A process according to claim 13 wherein said solid corn material comprises corn waste.

16. A process according to claim 15 wherein said compost comprises animal manure.

16. A process according to claim 13 wherein said bioremediation is conducted until at least 50% of said hydrocarbonaceous material is bioremediated.

17. A process according to claim 11 wherein said hydrocarbonaceous material is on a solid, particulate solid or liquid substrate and wherein said corn material comprises corn oil.

18. A process according to claim 17 wherein said corn oil is applied to said hydrocarbonaceous material by spraying.

19. A process according to clam 18 wherein said corn oil is emulsified in aqueous media before being sprayed onto said hydrocarbonaceous material.

20. A process according to claim 19 wherein said substrate comprises water or a beach and wherein said liquid media comprises an aqueous solution of said nutrients.
